(19) United States
(12) Patent Application Publication
(10) Pub. No.: US 2012/0215548 A1
(43) Pub. Date: Aug. 23, 2012

(54) TRADEMARK MAP CONSTRUCTION METHOD

(75) Inventors: CHUNG-JEN CHEN, TAINAN CITY (TW); CHAO-CHUN CHEN, TAINAN CITY (TW); CHIA-PI LIANG, TAINAN CITY (TW)

(73) Assignee: SOUTHERN TAIWAN UNIVERSITY OF TECHNOLOGY, TAINAN CITY (TW)

(21) Appl. No.: 13/030,333

(22) Filed: Feb. 18, 2011

(51) Int. Cl. G06Q 10/00

(52) U.S. Cl. 705/1.1

(57) ABSTRACT

A trademark map construction method is revealed. Firstly, select a range of trademarks intended to be analyzed and take background data of trademark samples required. Then integrate the above data to form a questionnaire having trademark modes and related serial number. Next invite people to divide the trademark samples into groups with similarity according to their subjective judgment and complete a corresponding matrix. Use Multi-Dimensional Scale (MDS) algorithms to process the above data so as to get relative distance between the trademark samples. Thus the distribution of the trademark samples in the trademark map is obtained. Thereby enterprises are provided with a trademark design reference and product recognition, positioning are also achieved.

### BACKGROUND OF THE INVENTION

1. Field of the Invention

The present invention relates to a trademark map construction method, especially to a trademark map construction method which displays similarities among trademarks of enterprises clearly by a trademark map and provides a trademark design reference during the trademark design of enterprises.

2. Description of Related Art

Brands are not only symbols for products but also used to create images on consumers immediately. The brand icon and self-image of the consumers are key points that drive consumer to purchase the products.

The higher brand awareness increases the likelihood of consumers to purchase its products. The brand awareness is closely related to the consumers' purchase intention. For the same products, consumers would like to pay more and buy the products with higher brand awareness, compared with products with a low brand image. When the brand is well known and popular, consumers gather information in the memory, associate brand names with the products and have brand preference. The brand loyalty is gradually built on positive experiences. This is the faithfulness of consumers to a particular brand, expressed through repeated purchases. Thus most companies use brand extension or brand stretching that makes use of the reputation of the existing brand name to increase the sales of products and services. Once brand loyalty is built, such loyalty is a great asset to the companies. Through recognition of brand identity, brand icons or brand messages, consumers purchase the products or services. Besides tangible products, the brand provides intangible feelings to the consumers. The brand's value will be enhanced by positive experiences the consumers have with the brand. The increased brand value is going to be a support for the company and even become a permanent asset of the enterprise.

A trademark, usually an exclusive and unique sign, is a first step of build a strong brand. The trademark is a word, phrase, symbol, or design or a combination thereof. The trademark is used by a company to identify and distinguish itself and its products or services to consumers from those of others. The essential function of a trademark is to help consumers identify the commercial source or origin of products or services and make the company well-known. The trademark represents the reputation or goodwill of the company and the quality of the products. The World Intellectual Property Organization (WIPO) defines the trademark in a wider manner—trademarks promote initiative and enterprise worldwide by rewarding the owners of trademarks with recognition and financial profit. Trademark protection also hinders the efforts of unfair competitors, such as counterfeiters, to use similar distinctive signs to market inferior or different products or services.

A trademark is a legally protected brand name and enterprises have exclusive right to use it on their products or services. Thus once consumers view a brand name, they connect this brand to another one and this is the standard ground for trademark infringement (similar marks). Now some bad businessmen use similar marks to cause confusion among consumers and take unfair advantage of the well-known mark or causing detriment to it. However, some well intentioned trademark designers and companies may design similar trademarks under the condition that they don't know the trademark has already been registered and used. This not only affects the trademark recognition of consumers, causes confusion among consumers and even raises trademark infringement problems.

In order to solve the above problems occurred during the trademark design process, there is a need to provide a method for trademark map construction for preventing possible confusion or infringement and benefiting the brand position.

### SUMMARY OF THE INVENTION

Therefore it is a primary object of the present invention to provide a trademark map construction method that displays similarities among trademarks of enterprises clearly by a trademark map and provides a trademark design reference during the trademark design process.

In order to achieve the above object, a trademark map construction method comprising the following steps.

A. analyzing trademark information: select a range of trademarks intended to be analyzed. Then retrieve several groups of background data of the trademark samples required from the Trademark Official Gazette published by the intellectual property office for data generalization.

B. establishing a trademark mode figure and a corresponding matrix: convert the above primary data into secondary data that includes only trademark modes and related serial number. Then integrate the trademark modes and the serial numbers to design a questionnaire. And invite different people to check similarity among the trademark samples, divide the trademark samples into different groups according to their subjective judgment and complete a corresponding matrix.

C. constructing a trademark map: process data of the above matrix by Multi-Dimensional Scale (MDS) algorithms so as to get relative distance between the trademark samples and the distribution of the trademark samples in the trademark map.

By the above steps, the method provides a reference to enterprises and ensure product recognition, positioning and effective distinctiveness during the trademark design period. The confusion of consumers caused by similar trademarks can be avoided.

At the same time, the design-around of the trademark is attained and the prevention of trademark infringement is achieved. And the trademark map is also used as a reference for intellectual property judges to determine whether the infringement exists between the trademarks of two parties.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a data list of an embodiment according to the present invention;

FIG. 2 is another data list of an embodiment according to the present invention;

FIG. 3 is a figure showing trademark modes and related serial numbers according to the present invention;

FIG. 4 is a matrix of an embodiment according to the present invention;

FIG. 5 is a trademark map showing distribution of trademarks according to the present invention.

### DETAILED DESCRIPTION OF THE PREFERRED EMBODIMENT

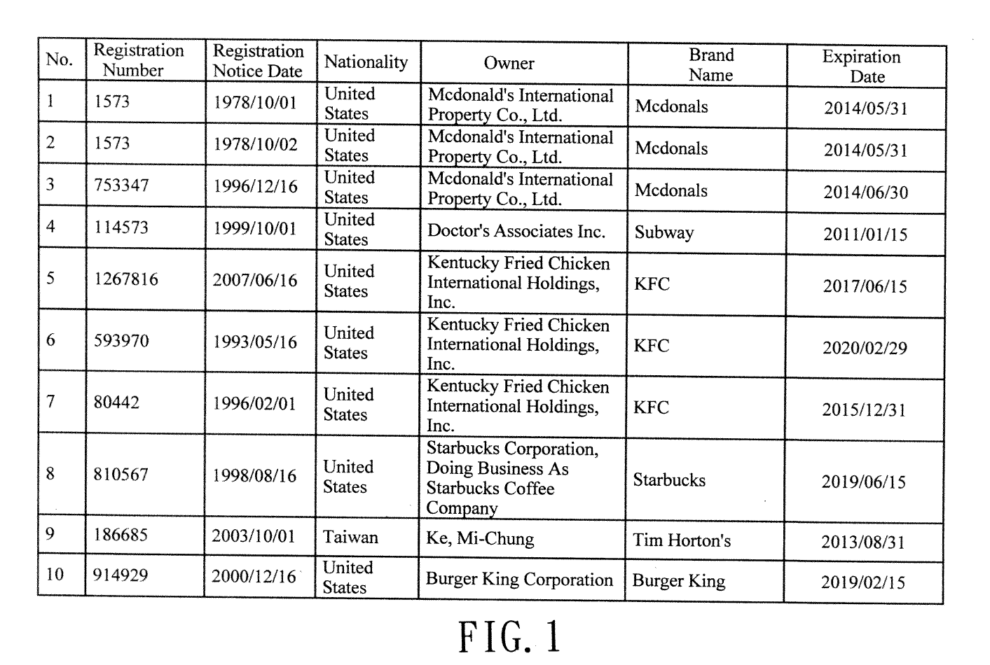

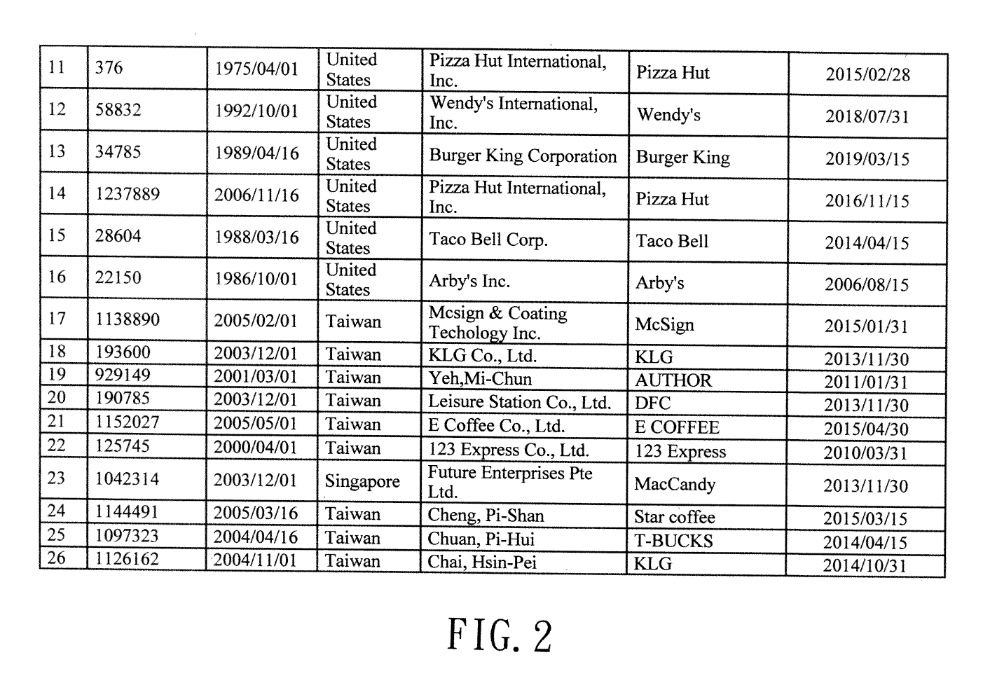

Refer from FIG. 1 to FIG. 2, a trademark map construction method of the present invention includes a plurality of steps.

A. analyzing trademark information: select a range of trademarks intended to be analyzed such as the fast food industry. Then retrieve six groups of background data of the trademark samples required from the Trademark Official Gazette published by the intellectual property office for data generalization. The six groups of background data includes (a) trademark registration number, (b) registration notice date, (c) nationality, (d) trademark owner, (e) brand name, and (f) trademark expiration date.

B. establishing a trademark mode figure and a corresponding matrix:

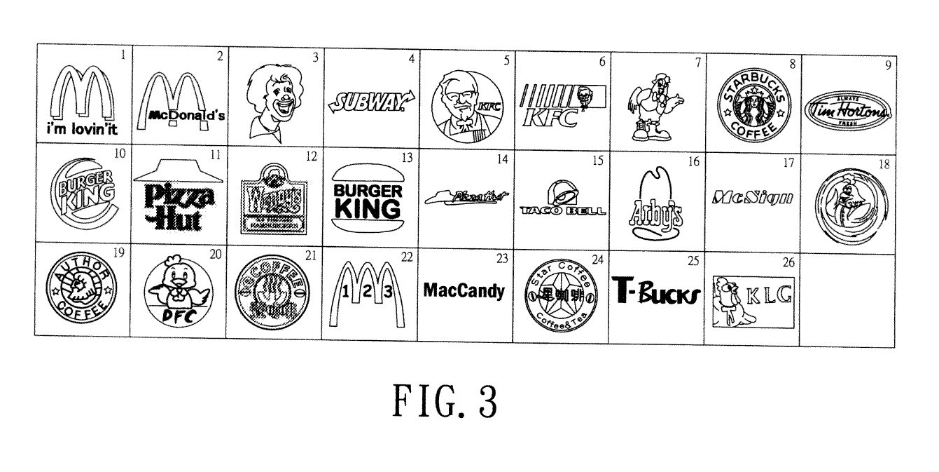

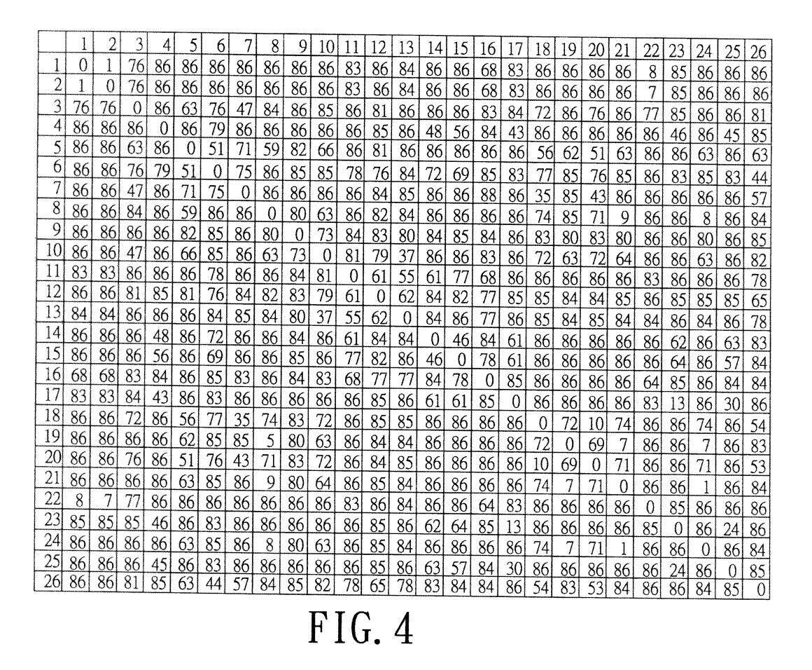

next convert the above primary data into secondary data, as shown in FIG. 3, including only trademark modes and related serial number. There is no word-related information provided. Then integrate the trademark modes with the serial numbers to design a questionnaire. Invite various people such as staffs working in the trademark field, trademark designers and general consumers to complete the questionnaire for checking the similarity of the trademark samples and dividing the trademark samples into different groups according to their subjective judgment. At the same time, a corresponding matrix is completed, as shown in FIG. 4.

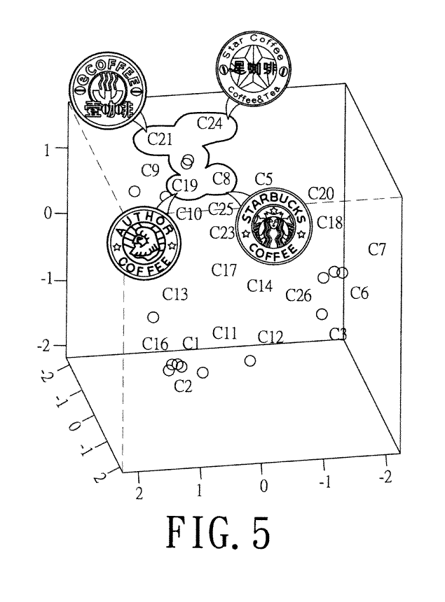

C. constructing a trademark map: process data of the above matrix by Multi-Dimensional Scale (MDS) algorithms and Statistics Package for the Social Sciences (SPSS) software so as to get relative distance between the trademark samples. Refer to FIG. 5, how the trademark samples are distributed in the trademark map under different dimensions is obtained.

Refer to FIG. 5, this is a trademark map of the fast food industry established by the trademark map construction method of the present invention. It is learned from the FIG. 5 that coffee shops in the fast food industry have similar trademark designs. For example, C8 Starbucks, C19 AUTHOR, C21 E COFFEE, and C24 Star coffee are similar to one another and are clustered. Thus the trademarks of coffee shops have a trademark cluster, all including a round mark as a foundation of recognition. Thus it is speculated that C19 AUTHOR, C21 E COFFEE, and C24 Star coffee entered the coffee shop market later than the C8 Starbucks follows the follows the leading enterprise C8 Starbucks to design their trademarks. The four trademarks, C8 Starbucks, C19 AUTHOR, C21 E COFFEE, and C24 Star coffee are highly similar to one another for people taken the questionnaire.

According to the trademark map constructed, the companies and the trademark designers can analyze trademarks of all competitors in the same field while designing trademark image and positioning the trademark so as to check and examine whether their own trademark is highly distinctive or deceptive for brand positioning. Their products can be distinguished from the competitors'. Thus the confusion caused by similarity of the trademark can be avoided. Thereby the design-around of the trademark is attained and the prevention of trademark infringement is achieved. Moreover, the trademark map can be an important reference for the intellectual property judge in dealing with the trademark infringement case.

In summary, the present invention has following advantages:

1. The trademark map construction method of the present invention is to set up an objective trademark recognition method. By analysis of the trademark data, the actual protection area of the trademark registration is defined. Moreover, the construction of the trademark map shows similarities among trademarks of different companies. The trademark map can also be used as a reference during the trademark design process.

2. The trademark map construction method of the present invention helps users to analyze trademarks of all competitors in the same industry and check whether their own trademark is distinctive or not. Moreover, through the construction of the trademark map, the brand positioning is performed for sufficient distinctiveness of the trademark to be distinguished from others.

3. The trademark map construction method of the present invention helps enterprises work out the design-around of trademarks. Besides prevention of trademark infringement, the trademark map can also be used as a reference for judges to determine whether the infringement exists between the trademarks of two parties.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A trademark map construction method comprising the steps of:
A. analyzing trademark information:
select a range of trademarks intended to be analyzed and retrieve a plurality groups of background data of trademark samples required from Trademark Official Gazette published by the intellectual property office for data generalization;
B. establishing a trademark mode figure and a corresponding matrix:
convert primary data of the background data into secondary data that includes trademark modes and related serial numbers; integrate the trademark modes with the serial numbers to design a questionnaire; and invite different people to check similarity among the trademark samples, divide the trademark samples into different groups according to their subjective judgment and complete a corresponding matrix;
C. constructing a trademark map:
process data in the corresponding matrix by Multi-Dimensional Scale (MDS) algorithms so as to get relative distance between the trademark samples and distribution of the trademark samples in a trademark map.

2. The method as claimed in claim 1, wherein in the step A of analyzing trademark information, the plurality groups of background data of trademark samples required include (a) trademark registration number, (b) registration notice date, (c) nationality, (d) trademark owner, (e) brand name, and (f) trademark expiration date.

3. The method as claimed in claim 1, wherein in the step B of establishing a trademark mode figure and a corresponding matrix, the different people include staffs working in the trademark field, designers and general consumers.

4. The method as claimed in claim 1, wherein in the step C of constructing a trademark map, the Multi-Dimensional Scale (MDS) algorithms are implemented by Statistics Package for the Social Sciences (SPSS) software.
